(19) United States
(12) Patent Application Publication
(10) Pub. No.: US 2024/0371171 A1
(43) Pub. Date: Nov. 7, 2024

(54) SYSTEMS AND METHODS OF AUTOMATICALLY DETECTING IMPROPER VEHICLE ROAD BEHAVIOR

(71) Applicant: TORC Robotics, Inc., Blacksburg, VA (US)

(72) Inventor: Daniel MOODIE, Blacksburg, VA (US)

(73) Assignee: TORC Robotics, Inc., Blacksburg, VA (US)

(21) Appl. No.: 18/311,620

(22) Filed: May 3, 2023

(51) Int. Cl. G06V 20/58; G06T 7/20; G06V 20/62

(52) U.S. Cl. CPC G06V 20/58; G06T 7/20; G06V 20/625; G06T 2207/30241; G06T 2207/30261

(57) ABSTRACT

A vehicle comprises one or more sensors, and a processor coupled with the one or more sensors and stored inside a housing of the vehicle. The processor can be configured to collect data regarding the environment surrounding the vehicle from the one or more sensors; detect a second vehicle and an observed trajectory of the second vehicle from the collected data, the observed trajectory indicating a position or speed of the second vehicle over a time period; compare the observed trajectory with one or more expected trajectories of the second vehicle; responsive to determining a deviation between the observed trajectory and at least one of the one or more expected trajectories satisfies a condition, generate a record indicating the deviation and including a video of the second vehicle that corresponds to the observed trajectory; and transmit the record to a remote processor.

### TECHNICAL FIELD

The present disclosure relates generally to autonomous vehicles and, more specifically, to systems and methods for automatically detecting improper vehicle road behavior.

### BACKGROUND

The use of autonomous vehicles has become increasingly prevalent in recent years, with the potential for numerous benefits, such as improved safety, reduced traffic congestion, and increased mobility for people with disabilities. However, with the deployment of autonomous vehicles on public roads, there is a growing concern about interactions between autonomous vehicles and negligent actors (whether human drivers or other autonomous systems) operating other vehicles on the road.

For proper operation, autonomous vehicles can collect large amounts of data regarding the surrounding environment. Such data may include data regarding other vehicles driving on the road, identifications of traffic regulations that apply (e.g., speed limits from speed limit signs or traffic lights), or other objects that impact how autonomous vehicles may drive safely.

### SUMMARY

The wide breadth of data that autonomous vehicles may collect while driving can enable autonomous vehicles to detect driving anomalies of other vehicles on the road. For example, because autonomous vehicles often do not communicate with other cars or drivers on the road, autonomous vehicles may collect data to predict actions of other vehicles to avoid potential collisions. Autonomous vehicles may collect data regarding the environment of vehicles that are adjacent to (e.g., share a lane line with or otherwise are in view of data collection systems of the autonomous vehicles) the autonomous vehicles and predict trajectories or actions that such vehicles may take on the road. Autonomous vehicles may determine control actions to take on their own to avoid the vehicles in view of the predicted trajectories (e.g., expected trajectories) or actions for the vehicles in the surrounding environment.

Autonomous vehicles may use the data collected regarding other vehicles on the road to identify which vehicles are not following laws or regulations. For example, an autonomous vehicle may detect a vehicle on the road that is adjacent to the autonomous vehicle. Upon detecting the vehicle, the autonomous vehicle may use data that the vehicle collects to control or navigate the autonomous vehicle to generate one or more expected trajectories (e.g., speeds or locations over time) of the detected vehicle. The autonomous vehicle can also detect an observed trajectory of the vehicle indicating the actual speed or trajectory of the detected vehicle over time. The autonomous vehicle can compare the observed trajectory with the expected trajectories to determine deviations between the observed trajectory and the expected trajectories. The autonomous vehicle can determine whether any deviations satisfy a condition (e.g., exceed a threshold). Such a condition can correspond to an unsafe driving action or breaking a law or regulation. Responsive to determining a deviation satisfies a condition, the autonomous vehicle can generate and transmit a record including an indication of the deviation to a remote processor.

In some cases, responsive to determining a deviation satisfies a condition, the autonomous vehicle can identify an image of the vehicle. The autonomous vehicle can identify the image responsive to the image including a license plate, a license plate number, or another identifier of the detected vehicle. The autonomous vehicle can include the image in the record that the autonomous vehicle transmits to the remote processor.

The remote processor can receive the record including the image and/or the indication of the deviation and process the data of the record. The remote processor can use object recognition techniques to identify the license plate, license plate number, or another identifier from the image. The remote processor can transmit a message to another remote processor (e.g., a processor of a computing device of a regulatory agency) that includes the identifier of the vehicle from the image and an indication of the deviation.

Accordingly, the autonomous vehicle and the remote processor may use the data that the autonomous vehicle collects to control the autonomous vehicle and to identify bad actors on the road. The autonomous vehicle and remote processor may transmit identifications of the bad actors (e.g., the detected vehicles) to regulatory agencies to inform the regulatory agencies of the deviations and which vehicles correspond to the deviations. Such can be advantageous, for example, to identify cars driving aggressively and/or dangerously. Examples of dangerous or aggressive driving that can be detected include swerving, tailgating, failing to use a turn signal, exceeding the speed limit, etc. The detected behavior can be behavior that does or does not impact or effect driving of the autonomous vehicle. The autonomous vehicle can additionally detect accidents, disabled vehicles, or vehicles experiencing malfunctions. By identifying bad actors on the road, regulatory agencies can take action against the individuals (e.g., drivers or owners) of the vehicles (or the vehicles themselves, such as in cases in which the vehicles are autonomous vehicles) for correction. Thus, implementing the systems and methods described herein can lead to safer roads.

In at least one aspect, the present disclosure describes a vehicle. The vehicle can include one or more sensors and a processor coupled with the one or more sensors and stored inside a housing of the vehicle. The processor can be configured to collect data regarding an environment surrounding the vehicle from the one or more sensors as the vehicle is driving (e.g., driving down the road); detect a second vehicle in a lane adjacent to the vehicle or in front of the vehicle and an observed trajectory of the second vehicle from the collected data, the observed trajectory indicating a position or speed of the second vehicle over a time period; compare the observed trajectory with one or more expected trajectories of the second vehicle; responsive to determining a deviation between the observed trajectory and at least one of the one or more expected trajectories satisfies a condition, generate a record indicating the deviation and including a video of the second vehicle that corresponds to the observed trajectory; and transmit the record to a remote processor.

In another aspect, the present disclosure describes a method. The method can include collecting, by a processor, data regarding an environment surrounding a vehicle from one or more sensors as the vehicle is driving (e.g., driving down the road); detecting, by the processor, a second vehicle in a lane adjacent to the vehicle or in front of the vehicle and an observed trajectory of the second vehicle from the collected data, the observed trajectory indicating a position or speed of the second vehicle over a time period; comparing, by the processor, the observed trajectory with one or more expected trajectories of the second vehicle; responsive to determining a deviation between the observed trajectory and at least one of the one or more expected trajectories satisfies a condition, generating, by the processor, a record indicating the deviation and including a video of the second vehicle that corresponds to the observed trajectory; and transmitting, by the processor, the record to a remote processor.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a bird's-eye view of a roadway including a schematic representation of a vehicle and aspects of an autonomy system of the vehicle, according to an embodiment.

FIG. 2 is a system for determining deviations between observed and expected trajectories of vehicles, according to an embodiment.

FIG. 3 is a method of determining deviations between observed and expected trajectories of vehicles, according to an embodiment.

FIG. 4 depicts a bird's-eye view of a roadway scenario of determining a deviation indicating a vehicle drove off the road, according to an embodiment.

### DETAILED DESCRIPTION

The following detailed description describes various features and functions of the disclosed systems and methods with reference to the accompanying figures. In the figures, similar components are identified using similar symbols, unless otherwise contextually dictated. The exemplary system(s) and method(s) described herein are not limiting and it may be readily understood that certain aspects of the disclosed systems and methods can be variously arranged and combined, all of which arrangements and combinations are contemplated by this disclosure.

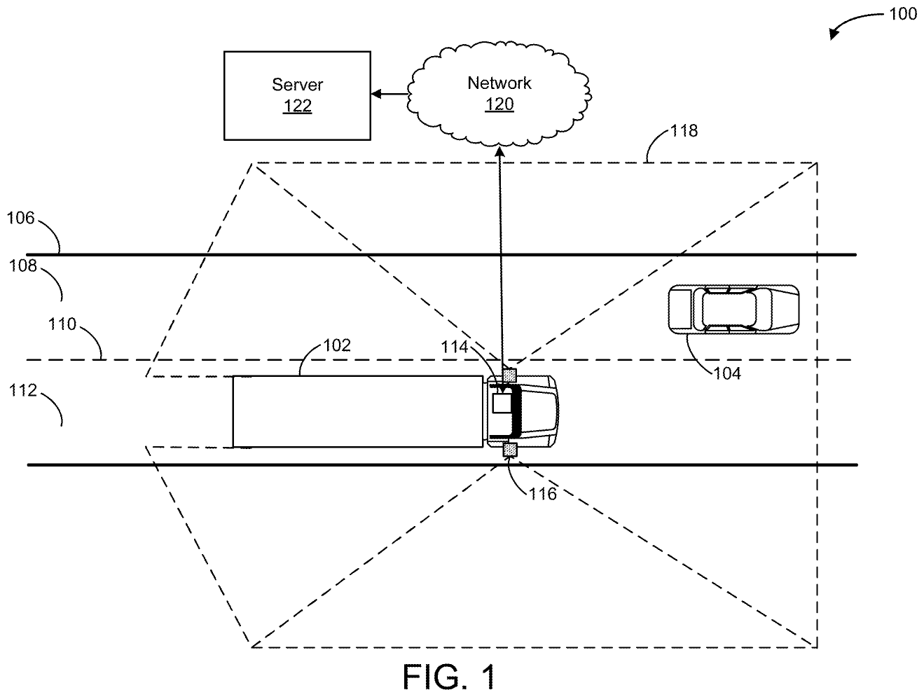

Referring to FIG. 1, the present disclosure relates to autonomous vehicles, such as an autonomous vehicle 102 having an autonomy system 114. The autonomy system 114 of the vehicle 102 may be completely autonomous (fully autonomous), such as self-driving, driverless, or Level 4 autonomy, or semi-autonomous, such as Level 3 autonomy. As used herein the term “autonomous” includes both fully autonomous and semi-autonomous. The present disclosure sometimes refers to autonomous vehicles as ego vehicles. The autonomy system 114 may be structured on at least three aspects of technology: (1) perception, (2) maps/localization, and (3) behaviors planning and control. The function of the perception aspect is to sense an environment surrounding the vehicle 102 and interpret the environment. To interpret the surrounding environment, a perception module 116 or engine in the autonomy system 114 of the vehicle 102 may identify and classify objects or groups of objects in the environment. For example, a perception module 116 may be associated with various sensors (e.g., light detection and ranging (LiDAR), camera, radar, etc.) of the autonomy system 114 and may identify one or more objects (e.g., pedestrians, vehicles, debris, etc.) and features of the roadway (e.g., lane lines) around the vehicle 102, and classify the objects in the road distinctly.

The maps/localization aspect of the autonomy system 114 may be configured to determine where on a pre-established digital map the vehicle 102 is currently located. One way to do this is to sense the environment surrounding the vehicle 102 (e.g., via the perception module 116), such as by detecting vehicles (e.g., a vehicle 104) or other objects (e.g., traffic lights, speed limit signs, pedestrians, signs, road markers, etc.) from data collected via the sensors of the autonomy system 114, and to correlate features of the sensed environment with details (e.g., digital representations of the features of the sensed environment) on the digital map.

Once the systems on the vehicle 102 have determined the location of the vehicle 102 with respect to the digital map features (e.g., location on the roadway, upcoming intersections, road signs, etc.), the vehicle 102 can plan and execute maneuvers and/or routes with respect to the features of the digital map. The behaviors, planning, and control aspects of the autonomy system 114 may be configured to make decisions about how the vehicle 102 should move through the environment to get to the goal or destination of the vehicle 102. The autonomy system 114 may consume information from the perception and maps/localization modules to know where the vehicle 102 is relative to the surrounding environment and what other objects and traffic actors are doing.

FIG. 1 further illustrates an environment 100 for modifying one or more actions of the vehicle 102 using the autonomy system 114. The vehicle 102 is capable of communicatively coupling to a remote server 122 via a network 120. The vehicle 102 may not necessarily connect with the network 120 or the server 122 while it is in operation (e.g., driving down the roadway). That is, the server 122 may be remote from the vehicle, and the vehicle 102 may deploy with all the necessary perception, localization, and vehicle control software and data necessary to complete the vehicle 102's mission fully autonomously or semi-autonomously.

While this disclosure refers to a vehicle 102 as the autonomous vehicle, it is understood that the vehicle 102 could be any type of vehicle including a truck (e.g., a tractor trailer), an automobile, a mobile industrial machine, etc. While the disclosure will discuss a self-driving or driverless autonomous system, it is understood that the autonomous system could alternatively be semi-autonomous having varying degrees of autonomy or autonomous functionality. While the perception module 116 is depicted as being located at the front of the vehicle 102, the perception module 116 may be a part of a perception system with various sensors placed at different locations throughout the vehicle 102.

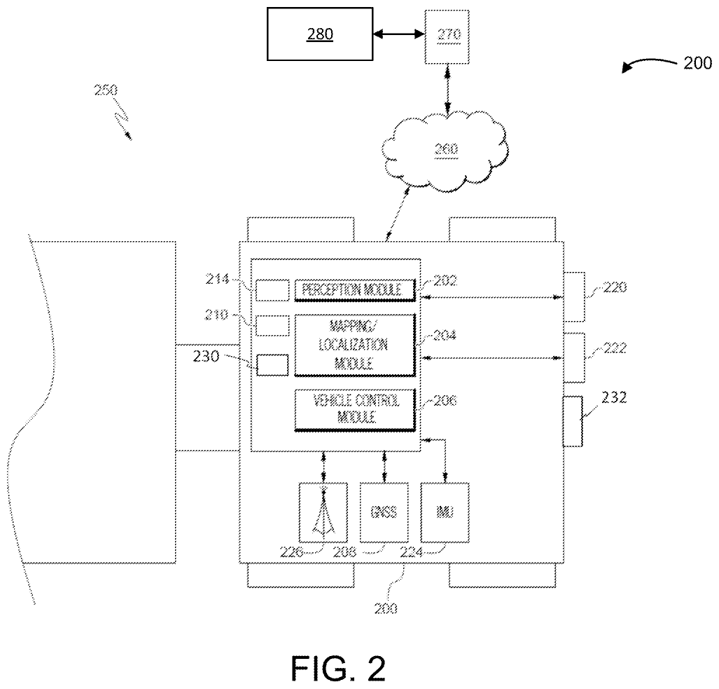

FIG. 2 illustrates an example schematic of an autonomy system 250 of a vehicle 200, according to some embodiments. The autonomy system 250 may be the same as or similar to the autonomy system 114. The vehicle 200 may be the same as or similar to the vehicle 102. The autonomy system 250 may include a perception system including a camera system 220, a LiDAR system 222, a radar system 232, a Global Navigation Satellite System (GNSS) receiver 208, an inertial measurement unit (IMU) 224, and/or a perception module 202. The autonomy system 250 may further include a transceiver 226, a processor 210, a memory 214, a mapping/localization module 204, and a vehicle control module 206. The various systems may serve as inputs to and receive outputs from various other components of the autonomy system 250. In other examples, the autonomy system 250 may include more, fewer, or different components or systems, and each of the components or system(s) may include more, fewer, or different components. Additionally, the systems and components shown may be combined or divided in various ways. As shown in FIG. 1, the perception systems aboard the autonomous vehicle may help the vehicle 102 perceive the vehicle 102's environment out to a perception area 118. The actions of the vehicle 102 may depend on the extent of the perception area 118. It is to be understood that the perception area 118 is an example area, and the practical area may be greater than or less than what is depicted.

The camera system 220 of the perception system may include one or more cameras mounted at any location on the vehicle 102, which may be configured to capture images of the environment surrounding the vehicle 102 in any aspect or field of view (FOV). The FOV can have any angle or aspect such that images of the areas ahead of, to the side, and behind the vehicle 102 may be captured. In some embodiments, the FOV may be limited to particular areas around the vehicle 102 (e.g., forward of the vehicle 102) or may surround 360 degrees of the vehicle 102. In some embodiments, the image data generated by the camera system(s) 220 may be sent to the perception module 202 and stored, for example, in memory 214.

The LiDAR system 222 may include a laser generator and a detector and can send and receive LiDAR signals. A LiDAR signal can be emitted to and received from any direction such that LiDAR point clouds (or “LiDAR images”) of the areas ahead of, to the side, and behind the vehicle 200 can be captured and stored as LiDAR point clouds. In some embodiments, the vehicle 200 may include multiple LiDAR systems and point cloud data from the multiple systems may be stitched together.

The radar system 232 may estimate strength or effective mass of an object, as objects made out of paper or plastic may be weakly detected. The radar system 232 may be based on 24 GHz, 77 GHz, or other frequency radio waves. The radar system 232 may include short-range radar (SRR), mid-range radar (MRR), or long-range radar (LRR). One or more sensors may emit radio waves, and a processor may process received reflected data (e.g., raw radar sensor data) from the emitted radio waves.

In some embodiments, the system inputs from the camera system 220, the LiDAR system 222, and the radar system 232 may be fused (e.g., in the perception module 202). The LiDAR system 222 may include one or more actuators to modify a position and/or orientation of the LiDAR system 222 or components thereof. The LiDAR system 222 may be configured to use ultraviolet (UV), visible, or infrared light to image objects and can be used with a wide range of targets. In some embodiments, the LiDAR system 222 can be used to map physical features of an object with high resolution (e.g., using a narrow laser beam). In some examples, the LiDAR system 222 may generate a point cloud and the point cloud may be rendered to visualize the environment surrounding the vehicle 200 (or object(s) therein). In some embodiments, the point cloud may be rendered as one or more polygon(s) or mesh model(s) through, for example, surface reconstruction. Collectively, the radar system 232, the LiDAR system 222, and the camera system 220 may be referred to herein as “imaging systems.”

The GNSS receiver 208 may be positioned on the vehicle 200 and may be configured to determine a location of the vehicle 200 via GNSS data, as described herein. The GNSS receiver 208 may be configured to receive one or more signals from a global navigation satellite system (GNSS) (e.g., a GPS) to localize the vehicle 200 via geolocation. The GNSS receiver 208 may provide an input to and otherwise communicate with the mapping/localization module 204 to, for example, provide location data for use with one or more digital maps, such as an HD map (e.g., in a vector layer, in a raster layer or other semantic map, etc.). In some embodiments, the GNSS receiver 208 may be configured to receive updates from an external network.

The IMU 224 may be an electronic device that measures and reports one or more features regarding the motion of the vehicle 200. For example, the IMU 224 may measure a velocity, acceleration, angular rate, and/or an orientation of the vehicle 200 or one or more of the vehicle 200's individual components using a combination of accelerometers, gyroscopes, and/or magnetometers. The IMU 224 may detect linear acceleration using one or more accelerometers and rotational rate using one or more gyroscopes. In some embodiments, the IMU 224 may be communicatively coupled to the GNSS receiver 208 and/or the mapping/localization module 204 to help determine a real-time location of the vehicle 200 and predict a location of the vehicle 200 even when the GNSS receiver 208 cannot receive satellite signals.

The transceiver 226 may be configured to communicate with one or more external networks 260 via, for example, a wired or wireless connection in order to send and receive information (e.g., to a remote server 270). The wireless connection may be a wireless communication signal (e.g., Wi-Fi, cellular, LTE, 5G, etc.). In some embodiments, the transceiver 226 may be configured to communicate with external network(s) via a wired connection, such as, for example, during initial installation, testing, or service of the autonomy system 250 of the vehicle 200. A wired/wireless connection may be used to download and install various lines of code in the form of digital files (e.g., HD digital maps), executable programs (e.g., navigation programs), and other computer-readable code that may be used by the system 250 to navigate the vehicle 200 or otherwise operate the vehicle 200, either fully autonomously or semi-autonomously.

The processor 210 of autonomy system 250 may be embodied as one or more of a data processor, a microcontroller, a microprocessor, a digital signal processor, a logic circuit, a programmable logic array, or one or more other devices for controlling the autonomy system 250 in response to one or more of the system inputs. The autonomy system 250 may include a single microprocessor or multiple microprocessors that may include means for controlling the vehicle 200 to switch lanes and monitoring and detecting other vehicles. Numerous commercially available microprocessors can be configured to perform the functions of the autonomy system 250. It should be appreciated that the autonomy system 250 could include a general machine controller capable of controlling numerous other machine functions. Alternatively, a special-purpose machine controller could be provided. Further, the autonomy system 250, or portions thereof, may be located remote from the system 250. For example, one or more features of the mapping/localization module 204 could be located remote to the vehicle 200. Various other known circuits may be associated with the autonomy system 250, including signal-conditioning circuitry, communication circuitry, actuation circuitry, and other appropriate circuitry.

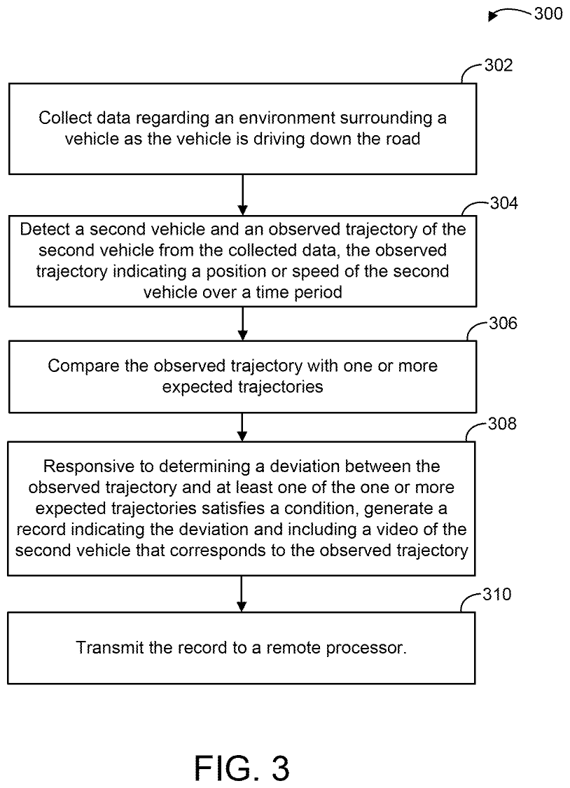

The memory 214 of the autonomy system 250 may store data and/or software routines that may assist the autonomy system 250 in performing autonomy system 250's functions, such as the functions of the perception module 202, the mapping/localization module 204, the vehicle control module 206, event detection module 230, and the method 300 described herein with respect to FIG. 3. Further, the memory 214 may also store data received from various inputs associated with the autonomy system 250, such as perception data from the perception system.

As noted above, the perception module 202 may receive input from the various sensors, such as the camera system 220, the LiDAR system 222, the GNSS receiver 208, and/or the IMU 224 (collectively “perception data”) to sense an environment surrounding the vehicle 200 and interpret it. To interpret the surrounding environment, the perception module 202 (or “perception engine”) may identify and classify objects or groups of objects in the environment. For example, the vehicle 102 may use the perception module 202 to identify one or more objects (e.g., pedestrians, vehicles, debris, etc.) or features of the roadway 106 (e.g., intersections, road signs, lane lines, etc.) before or beside a vehicle and classify the objects in the road. In some embodiments, the perception module 202 may include an image classification function and/or a computer vision function.

The system 250 may collect perception data. The perception data may represent the perceived environment surrounding the vehicle, for example, and may be collected using aspects of the perception system described herein. The perception data can come from, for example, one or more of the LiDAR system, the camera system, the radar system and various other externally-facing sensors and systems on board the vehicle (e.g., the GNSS receiver, etc.). For example, in vehicles having a sonar or radar system, the sonar and/or radar systems may collect perception data. As the vehicle 102 travels along the roadway 106, the system 250 may continually receive data from the various systems on the vehicle 102. In some embodiments, the system 250 may receive data periodically and/or continuously. With respect to FIG. 1, the vehicle 102 may collect perception data that indicates the presence of the lane line 110 (e.g., in order to determine the lanes 108 and 112). Additionally, the detection systems may detect the vehicle 104 and monitor the vehicle 104 to estimate various properties of the vehicle 104 (e.g., proximity, speed, behavior, flashing light, etc.). The properties of the vehicle 104 may be stored as timeseries data in which timestamps indicate the times in which the different properties were measured or determined. The features may be stored as points (e.g., vehicles, signs, small landmarks, etc.), lines (e.g., lane lines, road edges, etc.), or polygons (e.g., lakes, large landmarks, etc.) and may have various properties (e.g., style, visible range, refresh rate, etc.), which properties may control how the system 250 interacts with the various features.

The image classification function may determine the features of an image (e.g., a visual image from the camera system 220 and/or a point cloud from the LiDAR system 222). The image classification function can be any combination of software agents and/or hardware modules able to identify image features and determine attributes of image parameters in order to classify portions, features, or attributes of an image. The image classification function may be embodied by a software module that may be communicatively coupled to a repository of images or image data (e.g., visual data and/or point cloud data) which may be used to determine objects and/or features in real-time image data captured by, for example, the camera system 220 and the LiDAR system 222. In some embodiments, the image classification function may be configured to classify features based on information received from only a portion of the multiple available sources. For example, in the case that the captured visual camera data includes images that may be blurred, the system 250 may identify objects based on data from one or more of the other systems (e.g., the LiDAR system 222) that does not include the image data.

The computer vision function may be configured to process and analyze images captured by the camera system 220 and/or the LiDAR system 222 or stored on one or more modules of the autonomy system 250 (e.g., in the memory 214), to identify objects and/or features in the environment surrounding the vehicle 200 (e.g., lane lines). The computer vision function may use, for example, an object recognition algorithm, video tracing, one or more photogrammetric range imaging techniques (e.g., a structure from motion (SfM) algorithms), or other computer vision techniques. The computer vision function may be configured to, for example, perform environmental mapping and/or track object vectors (e.g., speed and direction). In some embodiments, objects or features may be classified into various object classes using the image classification function, for instance, and the computer vision function may track the one or more classified objects to determine aspects of the classified object (e.g., aspects of the vehicle 200's motion, size, etc.)

The mapping/localization module 204 receives perception data that can be compared to one or more digital maps stored in the mapping/localization module 204 to determine where the vehicle 200 is in the world and/or where the vehicle 200 is on the digital map(s). In particular, the mapping/localization module 204 may receive perception data from the perception module 202 and/or from the various sensors sensing the environment surrounding the vehicle 200 and correlate features of the sensed environment with details (e.g., digital representations of the features of the sensed environment) on the one or more digital maps. The digital map may have various levels of detail and can be, for example, a raster map, a vector map, etc. The digital maps may be stored locally on the vehicle 200 and/or stored and accessed remotely.

The vehicle control module 206 may control the behavior and maneuvers of the vehicle 200. For example, once the systems on the vehicle 200 have determined the vehicle 200's location with respect to map features (e.g., intersections, road signs, lane lines, etc.) the vehicle 200 may use the vehicle control module 206 and the vehicle 200's associated systems to plan and execute maneuvers and/or routes with respect to the features of the environment. The vehicle control module 206 may make decisions about how the vehicle 200 will move through the environment to get to the vehicle 200's goal or destination as it completes the vehicle 200's mission. The vehicle control module 206 may consume information from the perception module 202 and the mapping/localization module 204 to know where it is relative to the surrounding environment and what other traffic actors are doing.

The vehicle control module 206 may be communicatively and operatively coupled to a plurality of vehicle operating systems and may execute one or more control signals and/or schemes to control operation of the one or more operating systems, for example, the vehicle control module 206 may control one or more of a vehicle steering system, a propulsion system, and/or a braking system. The propulsion system may be configured to provide powered motion for the vehicle 200 and may include, for example, an engine/motor, an energy source, a transmission, and wheels/tires and may be coupled to and receive a signal from a throttle system, for example, which may be any combination of mechanisms configured to control the operating speed and acceleration of the engine/motor and thus, the speed/acceleration of the vehicle 200. The steering system may be any combination of mechanisms configured to adjust the heading or direction of the vehicle 200. The brake system may be, for example, any combination of mechanisms configured to decelerate the vehicle 200 (e.g., friction braking system, regenerative braking system, etc.) The vehicle control module 206 may be configured to avoid obstacles in the environment surrounding the vehicle 200 and may be configured to use one or more system inputs to identify, evaluate, and modify a vehicle trajectory. The vehicle control module 206 is depicted as a single module, but can be any combination of software agents and/or hardware modules able to generate vehicle control signals operative to monitor systems and control various vehicle actuators. The vehicle control module 206 may include a steering controller for vehicle lateral motion control and a propulsion and braking controller for vehicle longitudinal motion.

The event detection module 230 may detect events (e.g., reportable events) regarding vehicles in the surrounding area of the vehicle 102. Events may be or include determinations that a deviation between an expected trajectory for a vehicle and an observed trajectory for the same vehicle satisfies a condition (e.g., exceeds a threshold). For example, the event detection module 230 can collect data collected and/or generated through the perception module 202. From the collected data, the event detection module 230 can detect another vehicle in the surrounding environment (e.g., on the same road, such as in an adjacent lane to the vehicle 102) and determine expected trajectories for the detected vehicle. The event detection module 230 can detect an observed trajectory of the detected vehicle (e.g., an actual speed or position of the detected vehicle over time). The event detection module 230 can compare the observed trajectory of the detected vehicle with one or more expected trajectories. Based on the comparison, the event detection module 230, can determine one or more deviations between the observed trajectory and the one or more expected trajectories. The event detection module 230 can compare the one or more deviations with one or more conditions (e.g., thresholds that correspond with speed and/or position differences or deviations). Responsive to determining a condition is satisfied, the event detection module 230 can determine an event (e.g., a reportable event) has occurred. The event detection module 230 can transmit data regarding the event (e.g., data regarding the observed trajectory of the detected vehicle, the deviation that caused the event detection module 230 to detect the event, and/or one or more images of the detected vehicle associated with the event (e.g., with which the event was detected)). The event detection module 230 can transmit the data to the remote server 270.

The remote server 270 can receive the data regarding the event from the event detection module 230. Responsive to receiving the data, the remote server 270 can use object recognition techniques on the images of the detected vehicle. The remote server 270 can use such object recognition techniques to detect a license plate, a license plate number, and/or any other identifier of the detected vehicle. The remote server 270 can identify the identifier of the detected vehicle from the one or more images. The remote server 270 can then generate and transmit a message to a second remote server 280. The message can include the data of the event that the remote server 270 received from the event detection module 230 and the identifier of the detected vehicle.

The second remote server 280 can receive the message. The second remote server 280 can extract data from the message regarding the event and the detected vehicle. The second remote server 280 can identify a profile (e.g., a data structure in memory dedicated to storing data for a particular vehicle or individual) for the detected vehicle (or a driver of the detected vehicle) based on the identifier that the remote server 270 identified from the images of the detected vehicle. The second remote server 280 can store data from the message in the profile.

FIG. 3 shows execution steps of a processor-based method using the system 250, according to some embodiments. The method 300 shown in FIG. 3 comprises execution steps 302-310. However, it should be appreciated that other embodiments may comprise additional or alternative execution steps, or may omit one or more steps altogether. It should also be appreciated that other embodiments may perform certain execution steps in a different order. Steps discussed herein may also be performed simultaneously or near-simultaneously.

FIG. 3 is described as being performed by a data processing system stored or on or otherwise located at a vehicle, such as the autonomy system 250 depicted in FIG. 2. However, in some embodiments, one or more of the steps may be performed by a different processor, server, or any other computing feature. For instance, one or more of the steps may be performed via a cloud-based service or another processor in communication with the processor of an autonomous vehicle and/or the autonomy system of such an autonomous vehicle.

Using the method 300, the data processing system may detect events associated with different vehicles and transmit identifications of such events to a remote processor. A data processing system of a vehicle (e.g., a data processing system stored on and/or controlling the vehicle) can collect data regarding the surrounding environment of the vehicle over time. Using the collected data, the data processing system can detect or identify different vehicles that are traveling on a road over time. As the data processing system detects such vehicles, the data processing system can calculate one or more expected trajectories of the detected vehicles. The data processing system can do so based on the objects in front of or near the vehicles and/or based on other stored data the data processing system has regarding the road or the environment (e.g., a current speed limit). The data processing system can monitor the trajectory of a vehicle (e.g., speed and/or velocity of the vehicle) to generate an observed trajectory for the vehicle. The data processing system can compare the observed trajectory with one or more expected trajectories for the detected vehicle. The data processing system can determine the observed trajectory deviates from at least one of the one or more expected trajectories by an amount exceeding a threshold. Responsive to such a determination, the data processing system can generate a record that includes an identification of the deviation and transmit the identification of the deviation to a remote processor.

For example, at step 302, the data processing system collects data regarding the environment surrounding a vehicle. The data processing system can collect data regarding the environment from different sensor systems of the vehicle. For example, the data processing system can collect data regarding the environment using the vehicles LiDAR system, GPS, camera system, radar system, IMU, etc. Each of such systems can continuously capture or generate data regarding the surrounding environment of the vehicle (e.g., the area visible to individuals located within the vehicle or the area from which such systems can collect data). The systems may continuously or continually collect data and transmit the collected data to the data processing system as the vehicle drives.

The data that the data processing system can collect can relate to vehicles or other objects in the area surrounding the vehicle in which the data processing is located. For example, the data processing system can collect images, LiDAR data, or radar data depicting other vehicles on the same road as the data processing system, objects in the middle of the road, and/or signs or traffic lights around the road. The data processing system can also collect data related to the current location of the vehicle through the GPS. The data processing system can collect such data, tag the data with timestamps indicating the times in which the data processing system received the collected data (unless the data collection systems did not already tag the data) and store the tagged data in memory. The data processing system can retrieve and/or process such data from memory to detect other vehicles or objects in or on the road.

The data processing system can collect data over a network. The data processing system can do so using a transceiver, for example. Over the network, the data processing system can collect geolocation data indicating the location of the vehicle and/or characteristics of the environment surrounding the vehicle. In one example, the data processing system can transmit a current location of the vehicle to an external or remote processor. The external or remote processor can receive the location and identify a speed limit of the current location based on the received current location of the vehicle. The external or remote processor may also identify other aspects of the environment, such as upcoming road signs or traffic lights based on the current location. The external or remote processor may transmit identifications of such characteristics to the data processing system upon identifying the characteristics based on the current location of the vehicle.

At step 304, the data processing system detects a second vehicle and an observed trajectory of the second vehicle from the collected data. The second vehicle can be a vehicle traveling near (e.g., in the same lane as the vehicle or in a lane adjacent to the vehicle) the vehicle in which the data processing system is located. The data processing system can detect the second vehicle by processing data the data processing system collected regarding the surrounding environment. For example, the data processing system can collect image data and/or LiDAR data of the area around the vehicle over time. As the data processing system collects such image data and/or LiDAR data, the data processing system can use object recognition techniques on the image data (e.g., frames of images captured by the camera system) and/or LiDAR data. Using the object recognition techniques, the data processing system can identify or detect another vehicle (e.g., a second vehicle) in the environment around the vehicle in which the data processing system is located.

Upon detecting the second vehicle, the data processing system can begin monitoring the second vehicle. The data processing system can tag the image data and/or LiDAR data to indicate the second vehicle has been detected in the respective image data and/or LiDAR data. The data processing system can monitor the second vehicle by identifying the position of the second vehicle (e.g., the position of the vehicle relative to the vehicle in which the data processing system is located) relative to the road and/or relative to any other object. The data processing system can identify the position of the second vehicle by identifying objects surrounding the second vehicle from the same LiDAR data and/or image data from which the second vehicle was detected and comparing the position of the second vehicle with the identified objects surrounding the second vehicle.

The data processing system can also determine or detect the speed or velocity of the second vehicle. The data processing system can determine the speed of the second vehicle by determining the speed of the vehicle in which the data processing system is located and determining a difference between the speed of the vehicle and a captured or determined speed of the second vehicle. The data processing system can determine the speed of the second vehicle, for example, by comparing the location of the second vehicle within sequential frames of images and/or LiDAR data. The data processing system can determine the speed of the second vehicle using a radar gun. The data processing system can determine the speed of the second vehicle using any method.

The data processing system can determine or calculate expected trajectories of the second vehicle. Expected trajectories can be trajectories that the data processing system determines based on the objects surrounding the second vehicle that the data processing system identifies from the data that the data processing system collects and/or a current state (e.g., speed or act of turning or changing lanes) of the second vehicle. The expected trajectories can be trajectories that correspond with regulatory or safety requirements (e.g., expected trajectories can conform with a speed limit, following other roadway laws, such as stopping at stop signs or not crossing double-lined roads). In some cases, the expected trajectories may conform with ensuring safety around the second vehicle, such as avoiding a foreign object (e.g., a fallen tree or an animal) in the middle of the road. Expected trajectories may include combinations of any of such conditions (e.g., a trajectory can indicate a speed lower than the maximum speed and indicate to stay compliant with road regulations indicated by street signage). In some cases, expected trajectories can include expected characteristics of a vehicle, such as a flashing of one or more lamps (e.g., predetermined lamps, such as turn signals).

The data processing system can determine or calculate expected trajectories for the second vehicle in response to detecting the second vehicle. The data processing system can determine expected trajectories based on data that the data processing system collects regarding the surrounding environment. For example, the data processing system can determine an expected trajectory that conforms with the current speed limit of the road. The data processing system can identify the current speed limit from memory, such as after the data processing system identifies a speed limit sign on the side of the road or received an indication of the speed limit from a remote processor after transmitting an indication of the current location of the vehicle in which the data processing system is located. The data processing system can determine the expected trajectory to be a speed at or below the speed limit. In some cases, the expected trajectory can be or include a range of speeds below the speed limit. The range can include a lower bound and a maximum bound. The lower bound can be a minimum speed before it becomes dangerous to drive (which the data processing system may determine a maximum delta of the speed limit) or any value above such a minimum speed and below the speed limit. The maximum bound may be any value above the lower bound and below the speed limit. In some cases, the expected trajectory can include a value higher than the speed limit.

In another example, the data processing system can determine an expected trajectory that conforms with following road signs. For instance, the data processing system can identify a stop sign on the side of the road. Based on the stop sign, the data processing system can determine an expected trajectory in which the second vehicle stops at the stop sign. The data processing system can similarly determine trajectories that indicate for the second vehicle to follow any other road signs or traffic lights.

In another example, the data processing system can determine an expected trajectory that conforms with avoiding objects on the road. For instance, the data processing system can identify an object in the same lane as the second vehicle. The data processing system can determine a trajectory indicating a position (e.g., an expected position or a forecast position) of the second vehicle over time as the second vehicle would swerve around the object in the middle of the road. The data processing system can similarly determine an expected trajectory in which the object is a pedestrian crossing the road and the second vehicle stops or swerves to avoid the pedestrian. The data processing system can determine trajectories for any situation.

In another example, the data processing system can determine an expected trajectory that includes expected positions and/or locations based on any of the above or other criteria. For example, the data processing system can determine an expected trajectory that includes an expected speed that is at or less than the speed limit of the road and an expected position of the second vehicle over time to remain within the same lane. The data processing system can determine expected trajectories based on any of such criteria or conditions (e.g., trajectories that have paths to be within lane lines of a line, a speed at the speed limit, and/or to avoid an object in the middle of the lane or road).

The data processing system can determine expected trajectories for different lengths of time. For example, the data processing system can determine an expected trajectory for one second, two seconds, five seconds, ten seconds, etc. The data processing system can determine the lengths of time for such trajectories based on the visibility and/or speed of the environment of the vehicle in which the data processing system is located. For instance, the data processing system can use the LiDAR to determine the distance of the “vision” (e.g., area around the vehicle from which the data collection system can collect data) of the data collection systems of the vehicle in which the data processing system is located. The data processing system can determine the distance by calculating the length of time it takes to capture the reflection on average of LiDAR signals that the LiDAR system emits. The data processing system can calculate the average difference between transmission times and times of arrival of signals transmitted by the LiDAR system to calculate the vision of the data collection systems of the vehicle in which the data processing system is located. Such can be useful, for example, in foggy environments or in crowded environments (e.g., high-traffic environments or in the middle of a city). The data processing system can determine expected trajectories with higher lengths of time when the vision of the data collection system is higher and expected trajectories with lower lengths of time when the vision of the data collection system is lower.

The data processing system can determine multiple expected trajectories for the second vehicle. The data processing system can determine multiple expected trajectories for the second vehicle responsive to detecting the second vehicle. The data processing system can determine the multiple expected trajectories by executing an algorithm or model (e.g., set of executable code) that automatically generates variations of expected trajectories given a series of inputs (e.g., rules or criteria). The data processing system can input criteria such as the speed limit, identified objects and/or distances between the objects and the second vehicle, a value (e.g., average value) of the vision of the data collection systems of the vehicle in which the data processing system is located, and/or any other criteria related to driving on the road. The data processing system can execute the model, and the model can iteratively generate different expected trajectories that fall within the criteria (e.g., randomly sample different options for the different types of criteria to generate expected trajectories with different combinations of requirements, such different combinations of positions over time, speed over time, and/or lengths of time).

The data processing system can generate an observed trajectory of the second vehicle. The observed trajectory can indicate a position or speed of the second vehicle over a time period. The observed trajectory can be a position relative to one or more objects and/or speed of the second vehicle over a time period (e.g., a defined time period). Responsive to detecting the second vehicle from data collected by one or more of the data collection systems, the data processing system can continually or continuously collect data regarding the second vehicle for the time period. The data processing system can store indications of the speed and/or position or location of the second vehicle for the time period (e.g., indications of speed and/or position or location at a set time interval or for a set time period). The data processing system can detect the second vehicle in the data and label the data to indicate the data is related to the second vehicle. The data processing system can retrieve data that includes timestamps within the time period and a label indicating the second vehicle from memory. The data processing system can aggregate the data together to generate timeseries data indicating the location and/or speed of the second vehicle over throughout the time period. The observed trajectory can be or include the timeseries data indicating the speed and/or location of the second vehicle throughout the time period.

At step 306, the data processing system compares the observed trajectory with one or more expected trajectories. The data processing system can compare the observed trajectory with the one or more expected trajectories by comparing the values of the timeseries data of the observed trajectory with the values of each of the one or more expected trajectories (e.g., the expected trajectories that the data processing system can generate by executing a model). The data processing system can compare individual values with the values of each of the one or more expected trajectories and determine a difference or deviation between the expected trajectory and each of the expected trajectories, thus determining one or more differences or deviations.

In one example, an expected trajectory may include a single value of a speed (e.g., a speed limit) throughout the time period. The data processing system can identify the highest value of the speed of the observed trajectory. The data processing system can compare the identified highest value of speed with the single value of speed for the expected trajectory to determine a deviation between the observed trajectory and the expected trajectory.

In another example, the data processing system can compare the locations of the observed trajectory with positions or locations of the expected trajectory. The data processing system can determine deviations based on the comparison. The data processing system can identify the highest deviation as the deviation between the observed trajectory and the expected trajectory. The data processing system can similarly determine any number of deviations for any number of characteristics of the observed trajectory and one or more expected trajectories.

At step 308, the data processing system generates a record. The data processing system can generate the record in response to determining a deviation between the observed trajectory and at least one of the one or more expected trajectories satisfies a condition (e.g., exceeds a threshold, such as a predetermined threshold). A satisfied condition can correspond to an infraction (e.g., a driving infraction) such as aggressive or dangerous driving infractions. Such infractions may or may not correspond to violating a law or regulation. A satisfied condition can correspond to an accident or crash. The data processing system can compare each deviation that the data processing system determines between the observed trajectory and the one or more expected trajectories to one or more thresholds. Each threshold may correspond to the characteristic of the deviation (e.g., a threshold for speed may be different than a threshold for position or location). The data processing system can compare the deviations for speed with the threshold associated with speed and the deviations for position or location with the threshold associated with position or location. Based on the comparison, the data processing system can determine at least one of the deviations exceeds the threshold to which the deviation is compared. Responsive to determining a deviation exceeds a threshold, the data processing system can generate a record (e.g., a file, document, table, listing, message, notification, etc.) that indicates the deviation that exceeds the threshold.

In one example, the deviation can correspond to speed in the observed trajectory. The expected trajectory associated with speed can correspond to a speed limit of 55 miles per hour. The data processing system can determine a deviation between the observed speed (e.g., 60 miles per hour) and the expected speed of 55 miles per hour to be positive five miles per hour. The data processing system can compare the deviation of positive five miles per hour to a threshold of zero and determine the deviation exceeds the threshold. Responsive to the determination, the data processing system can generate a record that includes an identification of the observed speed of the second vehicle, the expected speed, and of the deviation.

In one example, the deviation can correspond to the positions or locations in the observed trajectory. For example, an expected trajectory can correspond to staying on a path or in a position within the lane of a road (e.g., the expected trajectory may include a value in inches or meters from the lane line over time). The expected trajectory can correspond to a position or location of a lane line in the middle of the road. The data processing system can compare the position of the vehicle relative to a lane line to the observed trajectory of the second vehicle. The data processing system can compare the values of the position to the expected values. The data processing system can identify values with identical or similar (e.g., within a threshold of each other) between the observed trajectory and the expected trajectory and compare the values with identical or similar timestamps to determine deviations. The data processing system can identify the largest deviation. The data processing system can compare the largest deviation to a stored threshold associated with locations. The data processing system can determine the deviation exceeds the threshold. Responsive to the determination, the data processing system can generate a record that includes an identification of the observed deviation of the second vehicle from the expected location. The data processing system can include a timestamp indicating a date and/or time of the satisfied condition (e.g., the time at the beginning of the observed trajectory of the second vehicle, the time at detection of the second vehicle, or time in which the data processing system determines expected trajectories for the second vehicle that cause the data processing system to determine the deviation satisfies a condition) in the record.

In another example, the data processing system can detect that the second vehicle crashed. For example, the data processing system can detect a speed of zero miles per hour or a position or location of the second as remaining in place. The data processing system can compare the observed speed or location of the second vehicle with one or more expected trajectories that cach indicate the second vehicle traveling over time. The data processing system can detect an event indicating the second vehicle is not moving based on a deviation between the observed speed or location and the expected trajectories exceeding a threshold. Advantageously, because the data processing system can determine events based on differences in observed trajectories and expected trajectories rather than only on the observed speed or location, the data processing system can differentiate between instances when a car is not moving because of traffic (e.g., an expected trajectory may indicate for the second not to move based on a car in front of the second vehicle remaining stationary) and when a car is in an accident, for example.

In another example, the data processing system can detect vehicles that are tailgating other vehicles. For example, the data processing system can detect the second vehicle and a third vehicle in front of the second vehicle. The data processing system can determine one or more expected trajectories for the second vehicle based on an expected position of the second vehicle relative to the position of the third vehicle. For example, an expected trajectory can include a distance between the second vehicle and the third vehicle. The data processing system can determine the distance, for example, as a stored position and/or based on a speed in which the second vehicle or the third vehicle are traveling. For instance, the data processing system can determine higher distances for higher speeds and lower distances for lower speeds. The data processing system can monitor the position of the second vehicle relative to the third vehicle and include values for the relative position of the second vehicle over time in the observed trajectory of the second vehicle. The data processing system can compare the relative position values of the observed trajectory with the expected trajectory to determine a deviation. In some cases, the data processing system can determine a deviation for each of the relative position values. The data processing system can compare the deviations to a threshold. The data processing system can determine a condition is satisfied responsive to determining at least one of the deviations exceeds the threshold or responsive to determining a number of deviations above a second threshold exceeds the threshold.

In another example, the data processing system can detect when vehicles do not correctly use a turn signal. For instance, based on the collected data, the data processing system can determine that the second vehicle is in the process of switching lanes on the road. Responsive to the determination, the data processing system can determine an expected trajectory for the second vehicle in which the second vehicle has activated a turn signal. The data processing system can use image analysis techniques on a video or pictures of the second vehicle as the second vehicle is changing lanes (e.g., an observed trajectory) to determine if the second vehicle activated a turn signal. Responsive to determining the second vehicle did not activate a turn signal, the data processing system can determine a condition is satisfied.

In another example, the data processing system can process video of vehicles after the vehicles have performed an action. For example, the data processing system can detect the second vehicle on the road. The data processing system can capture a video of the second vehicle as the second vehicle changes lanes. The data processing system can analyze the video of the second vehicle as the second vehicle changed lanes to determine if the second vehicle activated a turn signal (e.g., performed an expected trajectory) for the lane change. The data processing system can determine a condition is satisfied responsive to determining the second vehicle did not activate a turn signal (e.g., an observed trajectory) for the lane change (e.g., determine a deviation between the expected trajectory and the observed trajectory). The data processing system can use any characteristics of detected vehicles to determine deviations between expected trajectories and observed trajectories.

In some cases, the data processing system can insert an image of the second vehicle in the record. The data processing system may do so responsive to determining a deviation exceeds a threshold. For instance, the data processing may capture one or more images of the second vehicle as part of the data collection process. Responsive to determining a deviation between the observed trajectory of the second vehicle and an expected trajectory of the second vehicle exceeds a threshold, the data processing system may retrieve one of the captured images and insert or store the retrieved image in the record.

The data processing system may determine which image to transmit to the remote processor based on the contents of the images. For example, responsive to determining a deviation exceeds a threshold for the second vehicle, the data processing system may use object recognition techniques on the images that the camera system captures of the second vehicle. The data processing system may use such techniques to identify different objects within the images and determine which images include a license plate or license plate number of the second vehicle. The data processing system may parse through the images of the second vehicle iteratively performing object recognition techniques on the images until identifying an image that includes the license plate or the license plate number of the vehicle. Responsive to identifying such an image, the data processing system can insert the identified image into the record.

The data processing system can transmit video data of the second vehicle to the remote processor. For example, the data processing system can collect video data (e.g., a video) of the second vehicle performing the observed trajectory based on which the data processing system determined a deviation that satisfied a condition. The video can include video of the second vehicle before and/or after the time period of the observed trajectory. The data processing system can insert the video data and other data of the observed trajectory (e.g., the speed and/or position of the second vehicle) into the record.

The data processing system can include the location of the second vehicle or of the second vehicle in the record. The location can be the geographic location of the second vehicle at the beginning of the observed trajectory of the second vehicle, upon detection of the second vehicle, or at the time in which the data processing system determines expected trajectories for the second vehicle that cause the data processing system to determine the deviation satisfies a condition. The data processing system can collect the location using the GPS of the vehicle in which the data processing system is located (e.g., the location of the second vehicle can be the same location as the location of the vehicle or the data processing system can determine the location of the second vehicle by identifying the location of the vehicle from GPS data, determining vector indicating a difference in position in between the vehicle in which the data processing system is located and the second vehicle and direction of the difference, and aggregating the vector with the GPS data indicating the location of the vehicle). The data processing system can collect the location using the GPS responsive to detecting the vehicle and/or at set time intervals. The data processing system can store each location of the second vehicle in memory with a timestamp indicating the time in which the data processing system collected or generated the data. In cases in which the data processing system collects the location using the GPS, the data processing system can identify the location that corresponds to the timestamp closest to the beginning of the observed trajectory of the second vehicle, upon detection of the second vehicle, or at the time in which the data processing system determines expected trajectories for the second vehicle that cause the data processing system to determine the deviation satisfies a condition. The data processing system can insert the identified location and/or the timestamp of the identified location in the record.

At step 310, the data processing system transmits the record to a remote processor. The remote processor can be a processor of a cloud server, a virtual machine configured to perform processing on such records, or any other processor remote from the vehicle in which the data processing system is located. The data processing system can transmit the record to the remote processor over a network. The remote processor can receive the record. The remote processor can use object recognition techniques on the image to identify the license plate, the license plate number, and/or any other identifier (e.g., unique identifier) of the second vehicle. The remote processor can extract the deviation and/or any other data that is included in the record (e.g., video data of the observed trajectory or observed infractions and/or location data of the second vehicle) from the record. The data processing system can transmit the data from the record to a second remote processor over the network.

The second remote processor can be a processor of a computing device owned or otherwise accessed by a regulatory agency. The second remote processor can receive the data and store an association between the identifier of the second vehicle (e.g., the license plate number of the second vehicle) and the data in a database. The regulatory agency (e.g., the department of motor vehicles or a police office) can retrieve such data to determine which vehicles are not following laws or regulations or that otherwise are not driving safely. Further, in cases in which the data includes a video, the video can be used as evidence or proof of dangerous or aggressive driving on the road.

In some cases, the data processing system can insert a storage identifier into the generated record. The storage identifier can indicate to store any data related to the deviation that exceeds the threshold. The remote processor can receive the record and identify the storage identifier from the record. Responsive to identifying the storage identifier, the remote processor may retrieve and store the data related to the deviation (e.g., the video of the second vehicle, the location of the second vehicle, the timeseries data of the observed trajectory and/or the expected trajectories, etc.) in memory. The remote processor may not store other data that vehicles transmit to the remote processor. Accordingly, the data processing system may enable the remote processor to selectively store data, increasing the memory resources that are available at the remote processor.

In some cases, the data processing system may not generate a record after determining a deviation for a vehicle exceeds a threshold. For example, the data processing system can detect a third vehicle from data collected using the data collection systems. The data processing system can determine a second observed trajectory of the third vehicle from the collected data. The second observed trajectory can indicate a second position or speed of the third vehicle over a second time period. The data processing system can determine one or more second expected trajectories for the third vehicle based on the collected data as described herein. The data processing system can compare the second observed trajectory with one or more second expected trajectories. Based on the comparison, the data processing system can determine one or more deviations between the second observed trajectory and the one or more second expected trajectories. The data processing system can determine a second deviation between the second observed trajectory and at least one of the one or more second expected trajectories exceeds a threshold (e.g., the same threshold as was used to determine a deviation exceeds a threshold for the second vehicle or a different threshold (e.g., a second threshold)). Subsequent to determining the second deviation exceeds the threshold, the data processing system can detect an object in the path of the expected trajectory from which the deviation exceeding the threshold was determined (e.g., detect a pedestrian or a rock in the middle of the road that caused the third vehicle to speed up, swerve, or slow down and cause the deviation). Responsive to detecting an object, the data processing system can determine not to generate or transmit any records indicating the second deviation. Accordingly, the data processing system can adapt to real-time road conditions that the data processing system did not initially “see” (e.g., have data for when generating the expected trajectories) when determining whether to generate and/or transmit a record to a remote processor.

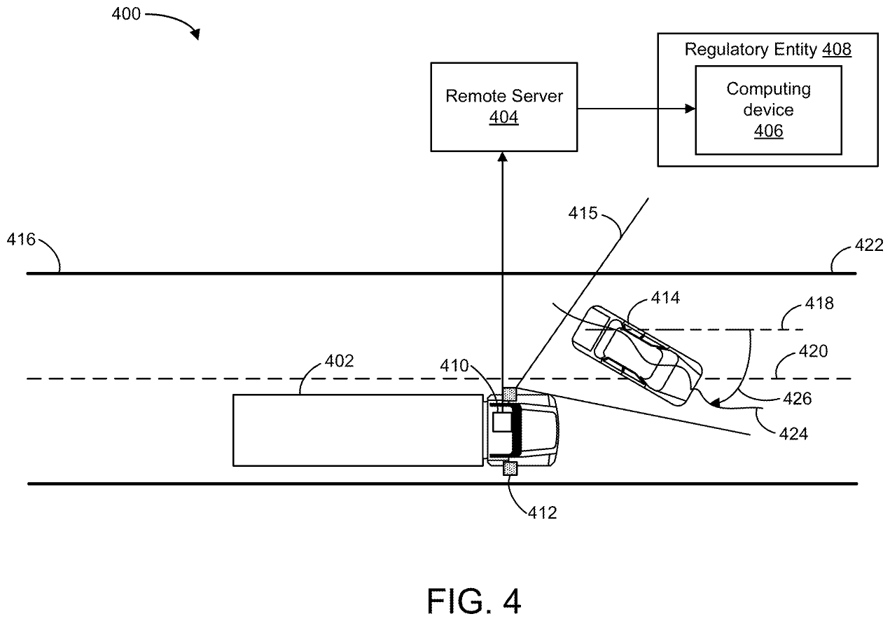

FIG. 4 depicts a bird's-eye view of a roadway scenario of determining a deviation indicating a vehicle drove off of the road, according to an embodiment. FIG. 4 illustrates an environment 400 that includes a vehicle 402, a remote server 404, and a computing device 406. The vehicle 402 can be the same as or similar to the vehicle 102. The remote server 404 can be the same as or similar to the remote server 122. The vehicle 402 can communicate with the remote server 404 over a network. The remote server 404 can communicate with the computing device 406 over the network. For example, the vehicle 402 can collect data regarding the surrounding environment of the vehicle 402. The vehicle 402 can process (e.g., pre-process) the collected data and transmit the processed data to the remote server 404. The remote server 404 can process the received data from the vehicle 402. The remote server 404 can transmit the processed data to the computing device 406. The computing device 406 can receive the data in memory.

The computing device 406 can be a computing device of a regulatory entity 408. The regulatory entity 408 can be an organization or company (e.g., an insurance company) that monitors events that occur on the road. Examples of regulatory entities can be or include entities such as the Department of Motor Vehicles, the local Police Department, the Federal Bureau of Investigation, or another business or organization. The regulatory entity 408 can own or operate the computing device 406. The computing device 406 can be configured to store data regarding different vehicles or drivers of vehicles in memory. For example, the computing device 406 can store profiles for drivers indicating characteristics of the drivers and different events (e.g., traffic tickets, crashes, traffic infractions, etc.). The computing device 406 can update the profiles as the remote server 404 transmits data regarding different drivers or vehicles to the computing device 406 after the vehicle 402 or the remote server 404 detects events regarding the drivers or vehicles of the profiles.

The vehicle 402 can include a data processing system 410 and a data collection system 412. The data processing system 410 can include a processor and memory. The data processing system 410 can be the same as or similar to the autonomy system 250, as described with reference to FIG. 2. The data collection system 412 can include one or more systems and/or devices configured to collect data regarding the surrounding environment of the vehicle 402. For instance, the data collection system 412 can include a camera system, a LiDAR system, a radar system, a GNSS receiver, a GPS, and/or an IMU. The data collection system 412 can be the same as or similar to the perception system described with reference to FIG. 2. The data collection system 412 can collect data as the vehicle 402 drives and transmit the collected data to the data processing system 410. The data processing system 410 can use the collected data to make control decisions for the vehicle 402 and operate the vehicle 402 based on the control decisions.

The data processing system 410 can detect a vehicle 414 as the vehicle 402 is driving down a road 416. The data processing system 410 can detect the vehicle 414 from data that the data collection system 412 regarding the environment surrounding the vehicle 402. The data processing system can detect the vehicle 414 from a field of view 415 of the data collection system 412. Responsive to detecting the vehicle 414, the data processing system 410 can determine one or more expected trajectories 418. The data processing system 410 can determine the expected trajectories 418 based on data that the data collection system 412 collects regarding obstacles or other characteristics of the road 416 that could impact the driving path of the vehicle 414. For instance, the data processing system 410 can determine the speed limit of the road 416 based on a speed limit sign that the data processing system 410 detected. The data processing system 410 can detect a lane marker 420 and a side 422 of the road 416 that indicates the lane for detected the vehicle 414 to stay within while driving down the road 416. The data processing system 410 can also determine that there are not any obstacles (e.g., fallen trees or pedestrians) in the road in front of the vehicle 414. Based on such determinations, the data processing system 410 can determine one or more expected trajectories 418 to have a speed below the speed limit and that indicate locations or positions between the lane marker 420 and the side 422 of the road 416.

The data processing system 410 can determine an observed trajectory 424. The data processing system 410 can determine the observed trajectory 424 based on data the data collection system 412 collects regarding the motion or speed of the vehicle 414. For example. after detecting the vehicle 414. the data processing system 410 can monitor the speed or location of the vehicle 414. The data processing system 410 can generate timeseries data for both the speed and the location of the vehicle 414 from the monitored data. The timeseries data can be or include the observed trajectory 424. As illustrated in FIG. 4. the observed trajectory 424 of the vehicle 414 can indicate that the vehicle 414 swerved over the lane marker 420 (e.g., swerved over the lane marker 420 in front of the vehicle 402. The observed trajectory 424 can indicate that the vehicle 414 was traveling over the speed limit of the road 416 when doing so.

The data processing system 410 can compare the expected trajectories 418 with the observed trajectory 424. The data processing system 410 can do so, for example, by comparing the timeseries data regarding the speed of the vehicle 414 and the timeseries data regarding the position of the vehicle 414 with the timeseries data of the expected trajectories 418. Based on the comparison, the data processing system 410 can determine deviations 426 between the expected trajectories 418 and the observed trajectory 424. The data processing system 410 can compare the deviations to one or more stored conditions in memory of the data processing system 410. Responsive to determining at least one deviation satisfies a condition (e.g., exceeds a threshold), the data processing system 410 can determine an event (e.g., a reportable event) occurred.

The data processing system 410 can transmit data regarding the event to the remote server 404. In doing so, the data processing system 410 can transmit the timeseries data of the observed trajectory 424 of the vehicle 414, the deviation 426 that satisfied the condition, an identifier of the condition that was satisfied (e.g., travelled above speed limit and/or drove off of the road), and one or more images of the vehicle 414 that the data processing system 410 received from the data collection system 412. In some cases, the data processing system 410 can transmit video of the vehicle 414 swerving over the lane marker 420 and/or a location of the vehicle 410 or the vehicle 414 when the swerving occurred. The data processing system 410 can transmit any data regarding the event to the remote server 404. By only transmitting data to the remote server 404 responsive to detecting an event instead of transmitting all data that the data collection system 412 collects, the data processing system 410 can conserve substantial bandwidth and/or computer resources.

The remote server 404 can analyze the data from the vehicle 402. The remote server 404 can use object recognition techniques on the one or more images that the remote server 404 receives from the vehicle 402. In doing so, the remote server 404 can identify the license plate and/or the license plate number of the vehicle 414. The remote server 404 can identify any such identifier (e.g., any other markings that uniquely identify the vehicle 414) of the vehicle 414. The remote server 404 can generate a message that includes all or a portion of the data that the remote server 404 received from the vehicle 402 and the identifier (e.g., the license plate number) of the vehicle 402. The remote server 404 can transmit the message to the computing device 406.

The computing device 406 can receive the message. The computing device 406 can identify the identifier of the vehicle 414 from the message. The computing device 406 can identify a profile in memory that corresponds to the identifier of the vehicle 414. The computing device 406 can store the data in the message in the identified profile that corresponds with the identifier of the vehicle 414. Accordingly, the computing device 406 can maintain and update a record indicating infractions or other events regarding the vehicle 414.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various components, blocks, modules, circuits, and steps have been generally described in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A vehicle comprising:
one or more sensors; and
a processor coupled with the one or more sensors and stored inside a housing of the vehicle, the processor configured to:
collect data regarding an environment surrounding the vehicle from the one or more sensors as the vehicle is driving;
detect a second vehicle in a lane adjacent to the vehicle or in front of the vehicle and an observed trajectory of the second vehicle from the collected data, the observed trajectory indicating a position or speed of the second vehicle over a time period;
compare the observed trajectory with one or more expected trajectories of the second vehicle;
responsive to determining a deviation between the observed trajectory and at least one of the one or more expected trajectories satisfies a condition, generate a record indicating the deviation and including a video of the second vehicle that corresponds to the observed trajectory; and
transmit the record to a remote processor.

2. The vehicle of claim 1, wherein the processor is further configured to:
detect a third vehicle and a second observed trajectory of the third vehicle from the collected data, the second observed trajectory indicating a second position or speed of the third vehicle over a second time period;
compare the second observed trajectory with one or more second expected trajectories of the third vehicle;
determine a second deviation between the second observed trajectory and at least one of the one or more second expected trajectories satisfies the condition or a second condition; and
responsive to detecting an object in the at least one of the one or more second expected trajectories, determine not to generate or transmit any records indicating the second deviation.

3. The vehicle of claim 2, wherein the processor is configured to detect the object subsequent to determining the second deviation.

4. The vehicle of claim 1, wherein the processor is configured to:
capture an image of the second vehicle from the collected data in response to determining the deviation satisfies the condition in response to determining the deviation satisfies the condition; and
insert the image of the second vehicle into the record.

5. The vehicle of claim 4, wherein the remote processor:
detects an identifier of the second vehicle from the image; and
transmits the identifier of the second vehicle an indication of the deviation to a second remote processor.

6. The vehicle of claim 5, wherein the remote processor detects the identifier of the second vehicle from the image using object recognition techniques.

7. The vehicle of claim 5, wherein the identifier of the second vehicle is a license plate number.

8. The vehicle of claim 5, wherein the second remote processor is a processor of a regulatory agency.

9. The vehicle of claim 1, wherein the processor is configured to:
determine the one or more expected trajectories based on the collected data.

10. The vehicle of claim 9, wherein the processor is configured to determine the one or more expected trajectories by:
identifying one or more objects in front of or next to the second vehicle; and
determine the one or more expected trajectories based on the one or more objects.

11. The vehicle of claim 1, wherein the at least one of the one or more expected trajectories comprises an expected speed, and
wherein the processor is configured to determine the deviation satisfies the condition by determining the speed of the second vehicle is greater than the expected speed maximum speed.

12. The vehicle of claim 1, wherein the processor is configured to generate the record by inserting a storage identifier into the record, the storage identifier causing the remote processor to store data of the record in memory.

13. The vehicle of claim 1, wherein the processor is configured to determine the deviation satisfies the condition by determining the deviation exceeds a threshold.

14. The vehicle of claim 1, wherein the processor is configured to insert a location of the second vehicle in the record.

15. A method comprising:
collecting, by a processor, data regarding an environment surrounding a vehicle from one or more sensors as the vehicle is driving;
detecting, by the processor, a second vehicle in a lane adjacent to the vehicle or in front of the vehicle and an observed trajectory of the second vehicle from the collected data, the observed trajectory indicating a position or speed of the second vehicle over a time period;
comparing, by the processor, the observed trajectory with one or more expected trajectories of the second vehicle;
responsive to determining a deviation between the observed trajectory and at least one of the one or more expected trajectories satisfies a condition, generating, by the processor, a record indicating the deviation and including a video of the second vehicle that corresponds to the observed trajectory; and
transmitting, by the processor, the record to a remote processor.

16. The method of claim 15, further comprising:
detecting, by the processor, a third vehicle and a second observed trajectory of the third vehicle from the collected data, the second observed trajectory indicating a second position or speed of the third vehicle over a second time period;
comparing, by the processor, the second observed trajectory with one or more second expected trajectories of the third vehicle;
determining, by the processor, a second deviation between the second observed trajectory and at least one of the one or more second expected trajectories satisfies the condition or a second condition; and
responsive to detecting an object in the at least one of the one or more second expected trajectories, determining, by the processor, not to generate or transmit any records indicating the second deviation.

17. The method of claim 16, wherein detecting the object comprises detecting, by the processor, the object subsequent to determining the second deviation.

18. The method of claim 15, comprising:
capturing, by the processor, an image of the second vehicle from the collected data in response to determining the deviation satisfies the condition in response to determining the deviation satisfies the condition; and
inserting, by the processor, the image of the second vehicle into the record.

19. The method of claim 18, wherein the remote processor:
detects an identifier of the second vehicle from the image; and
transmits the identifier of the second vehicle an indication of the deviation to a second remote processor.

20. The method of claim 19, wherein the remote processor detects the identifier of the second vehicle from the image using object recognition techniques.
